(19) United States
(12) Patent Application Publication
(10) Pub. No.: US 2026/0287456 A1
(43) Pub. Date: Sep. 24, 2026

(54) PRESSURE SENSOR

(71) Applicant: Murata Manufacturing Co., Ltd., Nagaokakyo-shi (JP)

(72) Inventor: Hisashi DEGUCHI, Nagaokakyo-shi (JP)

(21) Appl. No.: 19/681,350

(22) Filed: May 19, 2026

Related U.S. Application Data
(63) Continuation of application No. PCT/JP2024/036111, filed on Oct. 9, 2024.

(30) Foreign Application Priority Data
Jan. 4, 2024 (JP) 2024-000273

(51) Int. Cl. G01L 19/06; G01L 9/00; G01L 19/00; G01L 19/14

(52) U.S. Cl. CPC G01L 19/06; G01L 9/0044; G01L 19/0076; G01L 19/14

(57) ABSTRACT

A pressure sensor is provided for reducing adhesion of liquid to a detection portion. The pressure sensor includes a base member; a detection element on the base member and that has a detection portion; a covering member on the base member to cover at least a portion of the detection element other than the detection portion and that has a hole portion opened in an upper surface opposite to the base member to expose the detection portion; a soft member supported by an upper surface of the covering member and that is softer than the covering member; and a cover member supported by the soft member and that closes an opening of the hole portion. A gap space is present between the cover member and the soft member and is in communication with both the hole portion and a through hole in the cover member.

### CROSS REFERENCE TO RELATED APPLICATIONS

The present application is a continuation of International application No. PCT/JP2024/036111, filed Oct. 9, 2024, which claims priority to Japanese Patent Application No. 2024-000273, filed Jan. 4, 2024, the entire contents of each of which are incorporated herein by reference.

### TECHNICAL FIELD

The present disclosure relates to a pressure sensor that detects pressure from outside.

### BACKGROUND

A pressure sensor that detects pressure from outside is disclosed in International Publication No. 2019/208127 (the “'127 publication”).

In particular, the pressure sensor disclosed in the '127 publication includes a detection element provided on a base substrate; a resin package on the base substrate and in which the detection element is embedded, the resin package having an exposure hole through which a detection portion of the detection element is exposed to the outside; and a cylindrical member attached to the resin package and having a through hole in communication with the exposure hole. The pressure sensor detects pressure applied to the detection portion from outside through the through hole and the exposure hole.

When liquid, such as water, adheres to a detection portion, accurate detection of pressure applied to the detection portion is difficult as long as the adhering liquid is not removed.

In the pressure sensor disclosed in the '127 publication, the detection portion is provided inside the exposure hole. In this case, liquid enters the through hole and the exposure hole and adheres to the detection portion. In other words, the liquid adhering to the detection portion is present inside the exposure hole. Removing the liquid inside the exposure hole to the outside of the exposure hole is difficult. Therefore, in order to restart accurate detection by the detection portion to which the liquid adheres inside the exposure hole, it is necessary to wait for complete evaporation of the liquid inside the exposure hole.

### SUMMARY OF THE INVENTION

In view of the foregoing, it is an object of the present disclosure to provide a pressure sensor that reduces adhesion of liquid to a detection portion.

In an exemplary aspect, a pressure sensor is provided that includes a base member; a detection element on the base member and that has a detection portion; a covering member that is on the base member to cover at least a portion of the detection element other than the detection portion and that has a hole portion opened in an upper surface opposite to the base member; a soft member supported by an upper surface of the covering member and that is softer than the covering member; and a cover member supported by the soft member and that closes an opening of the hole portion. In this aspect, the detection portion of the detection element is exposed to the hole portion, a gap space is present in a portion between the cover member and the soft member, the cover member has a first surface that is directed to the soft member, a second surface that is opposite to the first surface, and a through hole that extends from the first surface to the second surface through the cover member, and the gap space is in communication with both the hole portion and the through hole.

According to the exemplary aspects of the present disclosure, adhesion of liquid to a detection portion is reduced.

### BRIEF DESCRIPTION OF DRAWINGS

FIG. 1 is a schematic plan view of a pressure sensor according to a first exemplary embodiment of the present disclosure.

FIG. 2 is a schematic cross-sectional view showing the A-A cross-section of FIG. 1.

FIG. 3 is a schematic plan view of a modification of the pressure sensor according to the first exemplary embodiment of the present disclosure.

FIG. 4 is a schematic plan view of a modification of the pressure sensor according to the first exemplary embodiment of the present disclosure.

FIG. 5 is a schematic cross-sectional view of a modification of the pressure sensor according to the first exemplary embodiment of the present disclosure, showing a cross-section at a position corresponding to the A-A cross-section of FIG. 1.

FIG. 6 is a schematic plan view of a modification of the pressure sensor according to the first exemplary embodiment of the present disclosure.

FIG. 7 is a schematic cross-sectional view of a pressure sensor according to a second exemplary embodiment of the present disclosure, showing a cross-section at a position corresponding to the A-A cross-section of FIG. 1.

### DETAILED DESCRIPTION OF EMBODIMENTS

Hereinafter, one example of the present disclosure will be described according to the accompanying drawings. The following description is merely exemplary in nature and is not intended to limit the present disclosure, applications thereof, or uses thereof. In addition, the drawings are schematic, and ratios of dimensions and the like do not necessarily coincide with actual ones. For purposes of this disclosure, it is noted that in the following description, terms (for example, terms including “upper”, “lower”, “right”, “left”, “front”, and “rear”) indicating specific directions or positions are used, as necessary. However, the use of the terms indicating specific directions or positions is for ease of understanding of the present disclosure with reference to the drawings, and the technical scope of the present disclosure is not limited by the meanings of these terms.

### First Exemplary Embodiment

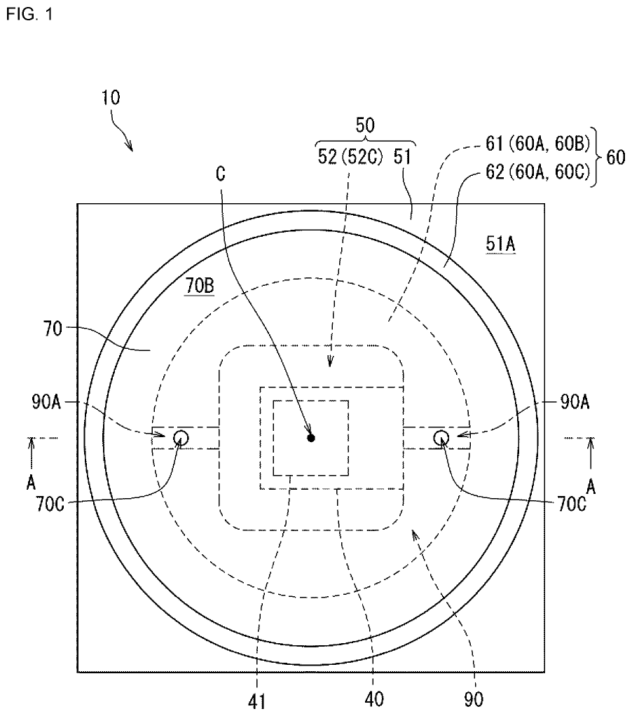

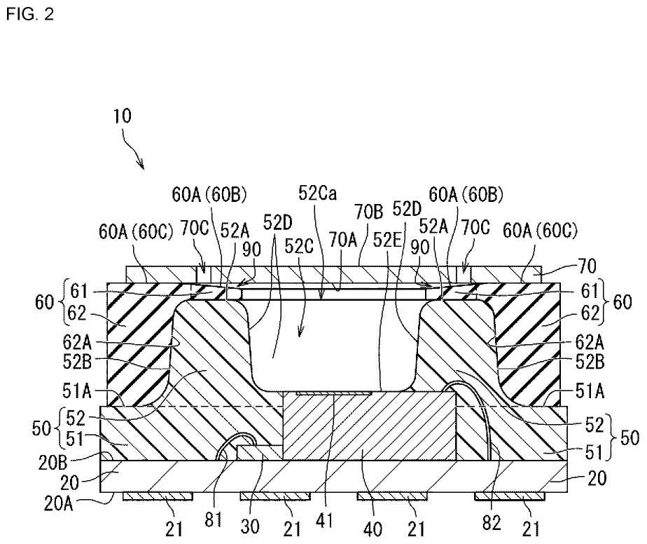

FIG. 1 is a schematic plan view of a pressure sensor according to a first exemplary embodiment of the present disclosure. FIG. 2 is a schematic cross-sectional view showing the A-A cross-section of FIG. 1. A pressure sensor 10 is configured to detect pressure and is to be equipped in, for example, a movable body, such as an automobile, an electronic device, such as a smartphone or a smartwatch, or the like.

As illustrated in FIG. 1 and FIG. 2, the pressure sensor 10 includes a base member 20, a circuit element 30, a detection element 40, a covering member 50, a soft member 60, and a cover member 70.

The base member 20 illustrated in FIG. 2 is a rigid substrate, such as a glass epoxy substrate or a ceramic substrate, but is not limited thereto. For example, the base member 20 may be a lead frame in an alternative exemplary aspect.

As illustrated in FIG. 2, an outer electrode 21 is provided at a lower surface 20A of the base member 20. When the pressure sensor 10 is equipped in another external device, for example, the aforementioned electronic device, the pressure sensor 10 is electrically connected to the electronic device through the outer electrode 21. Although four outer electrodes 21 are illustrated in FIG. 2, the number of the outer electrodes 21 included in the pressure sensor 10 is not limited to four and may be another number in alternative exemplary aspects.

As illustrated in FIG. 2, the circuit element 30 and the detection element 40 are mounted on an upper surface 20B of the base member 20. In other words, the circuit element 30 and the detection element 40 are provided on the base member 20. The base member 20 includes an electrode (not illustrated) at the upper surface 20B. The electrode provided at the upper surface 20B is electrically connected to the circuit element 30 through a bonding wire 81 and is electrically connected to the detection element 40 through a bonding wire 82. The bonding wires 81 and 82 are electrically connected to each other through a wiring pattern (not illustrated) provided at the upper surface 20B of the base member 20. Consequently, the circuit element 30 and the detection element 40 are electrically connected to each other. The circuit element 30 and the detection element 40 may be directly connected through a bonding wire. The electrode provided at the upper surface 20B can be electrically connected to, for example, an inner electrode provided inside the base member 20 or to the outer electrode 21 through a via conductor.

In the first exemplary embodiment, the circuit element 30 is an element that includes an application-specific integrated circuit (ASIC: Application Specific integrated Circuit). The circuit element 30 is bonded to the upper surface 20B of the base member 20 with, for example, a die attach film, a die attach material, or the like.

The circuit element 30 includes a signal processing circuit that processes a signal output from the detection element 40 and outputs the processed signal to the base member 20. For example, in the first exemplary embodiment, the circuit element 30 includes a converter, a filter, a temperature sensor, a processor, a memory, and the like. The converter converts a voltage signal output from the detection element 40 into a digital signal. The filter filters a digital signal from the converter. The temperature sensor detects temperature. The processor corrects a filtered digital signal on the basis of a temperature detected by the temperature sensor. The memory stores correction factors and the like that are to be used when a digital signal is to be corrected using a detected temperature.

The detection element 40 is a pressure sensor element for measuring pressure. The detection element 40 is, for example, a piezoresistive pressure sensor element or a capacitive pressure sensor element and is a microelectromechanical (MEMS: Micro Electromechanical Systems) element. The detection element 40 is bonded to the upper surface 20B of the base member 20 with, for example, a die attach film, a die attach material, or the like. Although the detection element 40 is mounted on the upper surface 20B of the base member 20 in the first exemplary embodiment, the detection element 40 may be mounted on the circuit element 30.

The detection element 40 includes, at an upper surface, a detection portion 41 to which pressure from the outside of the detection element 40 is applied. In other words, the detection portion 41 detects pressure. The detection portion 41 is, for example, a membrane or a diaphragm that receives pressure. The detection portion 41 may include, for example, a passivation film and may be waterproofed.

The covering member 50 is provided on the base member 20. The covering member 50 is, for example, a package that is formed by molding a hard resin such as a heat-curable resin onto the upper surface 20B of the base member 20. The upper surface 20B of the base member 20 is protected and waterproofed by being covered by the covering member 50.

The circuit element 30, the detection element 40, and the bonding wires 81 and 82 are embedded in the covering member 50. By being embedded in the covering member 50, the circuit element 30, the detection element 40, and the bonding wires 81 and 82 are protected and waterproofed.

A portion of the upper surface of the detection element 40 is not embedded in the covering member 50. Here, the portion of the upper surface of the detection element 40 includes the detection portion 41 provided at the upper surface and, of the upper surface, a peripheral part around the detection portion 41. In other words, the covering member 50 covers a part of the detection element 40 excluding the detection portion 41 and the peripheral part. That is, the covering member 50 covers the entirety of the part of the detection element 40 excluding the detection portion 41 and the peripheral part. The covering member 50 may cover the peripheral part. In other words, the covering member 50 may cover the entirety of a part of the detection element 40 excluding the detection portion 41. Therefore, the covering member 50 covers at least a portion of the part of the detection element 40 excluding the detection portion 41.

The covering member 50 includes a base portion 51 and a protruding portion 52.

In an exemplary aspect, the base portion 51 forms, of the covering member 50, the side close to the base member 20 in a vertical direction. The base portion 51 is in contact with the upper surface 20B of the base member 20. In the first exemplary embodiment, the circuit element 30, a lower portion of the detection element 40, the bonding wire 81, and a lower portion of the bonding wire 82 are covered by the base portion 51.

The protruding portion 52 protrudes from the base portion 51 to be separated from the base member 20. In other words, the protruding portion 52 protrudes upward from an upper surface 51A of the base portion 51. That is, in the first exemplary embodiment, the protruding direction of the protruding portion 52 is the vertical direction 100. In the exemplary aspect, the protruding portion 52 forms, in the covering member 50, a side of the base portion 51 opposite to the base member 20 in the vertical direction 100. In the first exemplary embodiment, an upper portion of the detection element 40 and an upper portion of the bonding wire 82 are covered by the protruding portion 52.

As further shown, the protruding portion 52 has an upper surface 52A and an outside surface 52B. The upper surface 52A is a top surface of the protruding portion 52. The upper surface 52A is located on a side of the protruding portion 52 opposite to the base member 20 in the vertical direction 100. The outside surface 52B extends downward from an outer edge portion of the upper surface 52A in a view along the vertical direction 100. The outside surface 52B connects the upper surface 52A of the protruding portion 52 to the upper surface 51A of the base portion 51.

As viewed along the vertical direction 100, the base portion 51 projects outward beyond the outside surface 52B of the protruding portion 52. In the first exemplary embodiment, the protruding portion 52 is provided at a central portion of the base portion 51 in a view along the vertical direction 100.

The protruding portion 52 has a hole portion 52C. The hole portion 52C has an opening 52Ca opened in the upper surface 52A. The hole portion 52C extends downward from the opening 52Ca toward the base portion 51. The hole portion 52C has an inside surface 52D and a bottom surface 52E. The inside surface 52D extends downward from an inner edge portion of the upper surface 52A in a view along the vertical direction 100. The inside surface 52D connects the upper surface 52A to the bottom surface 52E.

In the exemplary aspect, a part of the detection element 40 not covered by the covering member 50, in other words, the detection portion 41 of the detection element 40 and, of the upper surface of the detection element 40, a peripheral part around the detection portion 41 are exposed to the hole portion 52C. In the first exemplary embodiment, the bottom surface 52E of the hole portion 52C is formed by the detection portion 41, the peripheral part, and a resin that forms the protruding portion 52. In other words, the detection portion 41 and the peripheral part are each a portion of the bottom surface 52E of the hole portion 52C.

In the exemplary aspect, the detection portion 41 and the peripheral part may form the entirety of the bottom surface 52E. When the covering member 50 covers the entirety of the part of the detection element 40 excluding the detection portion 41, the entirety of the bottom surface 52E may be formed by the detection portion 41 and the resin that forms the protruding portion 52, or the entirety of the bottom surface 52E may be formed by only the detection portion 41.

The shape of the hole portion 52C is a tapered shape in which, as illustrated in FIG. 2, a cross-sectional area along an imaginary surface orthogonal to the vertical direction 100 decreases from the opening 52Ca toward the detection portion 41 of the detection element 40 in the first exemplary embodiment, but may be another shape. For example, the inside surface 52D of the hole portion 52C may extend straight downward. It is sufficient for the hole portion 52C to be configured as a pressure introduction hole through which a pressure is introduced into the detection portion 41.

The soft member 60 is located on a side of the covering member 50 opposite to the base member 20 in the vertical direction 100. The soft member 60 is supported by the covering member 50. In detail, the soft member 60 is in contact with the upper surface 51A of the base portion 51, the upper surface 52A of the protruding portion 52, and the outside surface 52B of the protruding portion 52 and is supported by the upper surfaces 51A and 52A and the outside surface 52B.

In the exemplary aspect, the soft member 60 is formed by a material that is softer than the covering member 50. In the first exemplary embodiment, the soft member 60 is formed by, for example, silicone, rubber, or the like. It is sufficient for the soft member 60 to be a material softer than the covering member 50, and the material is not limited to silicone or rubber as would be appreciated to one skilled in the art.

In the first exemplary embodiment, the covering member 50 and the soft member 60 are integrally formed by two-shot molding. The covering member 50 and the soft member 60 may be joined by means, other than two-shot molding, such as thermocompression bonding or bonding with an adhesive.

The soft member 60 has a support portion 61 and a surrounding portion 62.

The support portion 61 is an inward portion of the soft member 60 as viewed along the vertical direction 100. The support portion 61 is in contact with the upper surface 52A of the protruding portion 52 and is supported by the upper surface 52A. As viewed along the vertical direction 100, the support portion 61 is annular and is provided so as to surround the opening 52Ca of the hole portion 52C of the protruding portion 52. In other words, the soft member 60 does not close the opening 52Ca of the hole portion 52C. The support portion 61 may project to be directly above the hole portion 52C. In this case, the support portion 61 projecting to be directly above the hole portion 52C does not completely close the opening 52Ca of the hole portion 52C. Therefore, communication of a gap space 90, described later, with the hole portion 52C is not obstructed.

In the exemplary aspect, the surrounding portion 62 is integrally formed with the support portion 61. The surrounding portion 62 is an outward part of the soft member 60 as viewed along the vertical direction 100. The surrounding portion 62 is in contact with the upper surface 51A of the base portion 51 and is supported by the upper surface 51A. As viewed along the vertical direction 100, the surrounding portion 62 is annular and is provided so as to surround the protruding portion 52. The surrounding portion 62 has an inner circumferential surface 62A. The inner circumferential surface 62A is in contact with the outside surface 52B of the protruding portion 52. Consequently, a gap between the soft member 60 and the protruding portion 52 is closed. The surrounding portion 62 is also supported by, in addition to the upper surface 51A, the outside surface 52B.

An upper surface of the soft member 60 is a facing surface 60A that faces a first surface 70A of the cover member 70, the first surface 70A being the lower surface of the cover member 70, in the vertical direction 100. The facing surface 60A is, among surfaces of the soft member 60, a surface located opposite to the covering member 50 in the vertical direction 100.

As further shown, the facing surface 60A has a separated surface 60B and a support surface 60C. The separated surface 60B is provided at the support portion 61. The separated surface 60B is separated from the first surface 70A of the cover member 70. The support surface 60C is provided at the surrounding portion 62. The support surface 60C is in contact with the first surface 70A of the cover member 70 and supports the first surface 70A. In other words, the support surface 60C is located closer to the first surface 70A than the separated surface 60B.

The separated surface 60B is inclined downward as the separated surface 60B extends inward as viewed along the vertical direction 100. In other words, the separated surface 60B is inclined to be separated from the first surface 70A of the cover member 70 as the separated surface 60B approaches the hole portion 52C.

As illustrated in FIG. 1, the separated surface 60B is provided over the entire region of the facing surface 60A in the circumferential direction of the annular protruding portion 52. For example, as illustrated as a region surrounded by the two dash-dotted lines and the two dashed lines in FIG. 1, the separated surface 60B may be provided at only a portion of the facing surface 60A in the circumferential direction of the annular protruding portion 52. In this case, a part where the separated surface 60B is not provided in the circumferential direction of the annular protruding portion 52 is the support surface 60C.

As illustrated in FIG. 2, the cover member 70 is located on a side of the soft member 60 opposite to the covering member 50 in the vertical direction 100. The cover member 70 is supported by the support surface 60C of the facing surface 60A of the soft member 60. The cover member 70 is provided above the opening 52Ca of the hole portion 52C. In other words, the cover member 70 closes the opening 52Ca of the hole portion 52C from above.

In the first exemplary embodiment, the cover member 70 is formed by a resin such as a liquid crystal polymer. However, it is noted that the cover member 70 is not limited to being formed a resin and may be formed by, for example, a metal such as stainless steel (SUS). In the first exemplary embodiment, the cover member 70 is configured to be harder than the soft member 60 but may be softer than the soft member 60 or may have the same hardness as the soft member 60. The cover member 70 is joined to the soft member 60 with, for example, an adhesive.

The cover member 70 has the first surface 70A and a second surface 70B. The first surface 70A is the lower surface of the cover member 70 and is directed to the soft member 60 and the hole portion 52C of the covering member 50. The second surface 70B is the upper surface of the cover member 70 and is located opposite to the first surface 70A in the vertical direction 100.

The first surface 70A faces the facing surface 60A of the soft member 60 in the vertical direction 100. Moreover, the first surface 70A is separated from the separated surface 60B of the facing surface 60A of the soft member 60. With the first surface 70A being separated from the separated surface 60B, the gap space 90 is provided between the first surface 70A and the separated surface 60B. In other words, the separated surface 60B is directed to the gap space 90. In contrast, due to the first surface 70A being in contact with the support surface 60C of the facing surface 60A of the soft member 60, the gap space 90 is not provided between the first surface 70A and the support surface 60C. That is, the gap space 90 is provided at a portion between the cover member 70 and the soft member 60.

The gap space 90 is in communication with the inside of the annular support portion 61 of the soft member 60. In other words, the gap space 90 is in communication with a hole part of the annular support portion 61. Consequently, the gap space 90 is in communication with the hole portion 52C of the covering member 50.

As illustrated in FIG. 1 and FIG. 2, the cover member 70 has two through holes 70C. Each of the two through holes 70C extends from the first surface 70A to the second surface 70B through the cover member 70 in the vertical direction 100. The number of the through holes 70C of the cover member 70 is not limited to two and may be a different number of holes in alternative exemplary aspects.

Each of the two through holes 70C overlaps the gap space 90 as viewed along the vertical direction 100. Consequently, the gap space 90 is in communication with the through holes 70C.

Therefore, the detection portion 41 of the detection element 40 is in communication with the outside of the pressure sensor 10 through the hole portion 52C, the gap space 90, and the through holes 70C. Therefore, a gas that acts on the second surface 70B of the cover member 70 acts on the detection portion 41 through the through holes 70C, the gap space 90, and the hole portion 52C. Consequently, the detection element 40 is configured to measure a pressure applied to the detection portion 41 by the gas acting on the detection portion 41.

As illustrated in FIG. 1, each of the two through holes 70C is circular as viewed along the vertical direction 100. In other words, each of the two through holes 70C is cylindrical. As viewed along the vertical direction 100, the two through holes 70C are provided at positions at which the through holes 70C are point-symmetric with respect to a center C of the pressure sensor 10. The two through holes 70C are identical in shape and size.

In general, it is noted that the sizes, the shapes, and the positions of the through holes 70C are not limited to the sizes, the shapes, and the positions such as those illustrated in FIG. 1 and FIG. 2 and those as described above. The through holes 70C may be identical to each other or different from each other in shape and size. The positions of the through holes 70C may be positions that are not point-symmetric with respect to the center C of the pressure sensor 10.

In the first exemplary embodiment, the sizes, the shapes, and the positions of the through holes 70C are set to satisfy both a first condition and a second condition.

The first condition is a condition under which, when a first pressure is applied to the second surface 70B by liquid adhering to the second surface 70B so as to cover the through holes 70C, the liquid covering the through holes 70C enters the through holes 70C.

The first pressure is a high pressure. For example, when the first pressure is applied to the second surface 70B by liquid adhering to the second surface 70B, the first pressure is higher than the surface tension of liquid located at a boundary with respect to the openings of the through holes 70C. Consequently, the liquid enters the through holes 70C.

The second condition is a condition under which, when a second pressure lower than the first pressure is applied to the second surface 70B by liquid adhering to the second surface 70B so as to cover the through holes 70C, the liquid covering the through holes 70C does not enter the through holes 70C.

The second pressure is a slight pressure. For example, even when the second pressure is applied to the second surface 70B by liquid adhering to the second surface 70B, the second pressure is lower than the surface tension of liquid located at a boundary with respect to the openings of the through holes 70C. Therefore, the liquid continues to be located at the boundary with respect to the openings of the through holes 70C due to the surface tension and does not enter the through holes 70C.

When the first pressure is applied to the second surface 70B by liquid adhering to the second surface 70B, the soft member 60 is compressed by the application of the first pressure. Consequently, the separated surface 60B of the soft member 60 comes into contact with the first surface 70A of the cover member 70. As a result, at least a portion of the gap space 90 is closed. In other words, the first pressure is a pressure with which the above-described closure of the gap space 90 occurs.

When the second pressure is applied to the second surface 70B by liquid adhering to the second surface 70B, compression of the soft member 60 by the application of the second pressure is smaller than compression of the soft member 60 by the application of the first pressure. In other words, when the second pressure is applied to the second surface 70B by liquid adhering to the second surface 70B, the soft member 60 is not compressed by the application of the second pressure. Therefore, a state in which the separated surface 60B of the soft member 60 is separated from the first surface 70A of the cover member 70 is maintained. As a result, communication of the through holes 70C with the hole portion 52C through the gap space 90 is maintained. In other words, the second pressure is a pressure with which the above-described communication of the through holes 70C with the hole portion 52C through the gap space 90 is maintained.

For example, the first pressure is a pressure higher than 1 bar (bar), that is, 100 kilopascals (kPa), and the second pressure is a pressure lower than 1 bar.

### Modifications

It is noted that configurations such as the shapes and sizes of components included in the pressure sensor 10, for example, the base member 20, the detection element 40, the covering member 50, the soft member 60, and the cover member 70 are not limited to configurations such as those described above and those illustrated in the drawings. For example, the shape of the protruding portion 52 of the covering member 50 is a cylindrical shape in FIG. 1 and FIG. 2 but may be another shape such as a quadrangular columnar shape in an alternative exemplary aspect. In addition, for example, the cover member 70, which has a disk shape, may have another shape such as a quadrangular plate shape. Further, the soft member 60 only needs to be supported by the upper surface of the covering member 50. Therefore, for example, although the soft member 60 in the first exemplary embodiment includes the support portion 61 and the surrounding portion 62, the soft member 60 may include only the support portion 61 without including the surrounding portion 62.

In the pressure sensor 10 illustrated in FIG. 1 and FIG. 2, the through holes 70C are present at positions to overlap the support portion 61 of the soft member 60 in the vertical direction 100. The positions of the through holes 70C are, however, optional on the condition under which the through holes 70C are in communication with the gap space 90. For example, the through holes 70C may be present at positions to overlap the surrounding portion 62 of the soft member 60 in the vertical direction 100. In this case, the separated surface 60B is provided over both the support portion 61 and the surrounding portion 62, and the through holes 70C are present at positions to overlap the separated surface 60B provided at the surrounding portion 62 in the vertical direction 100.

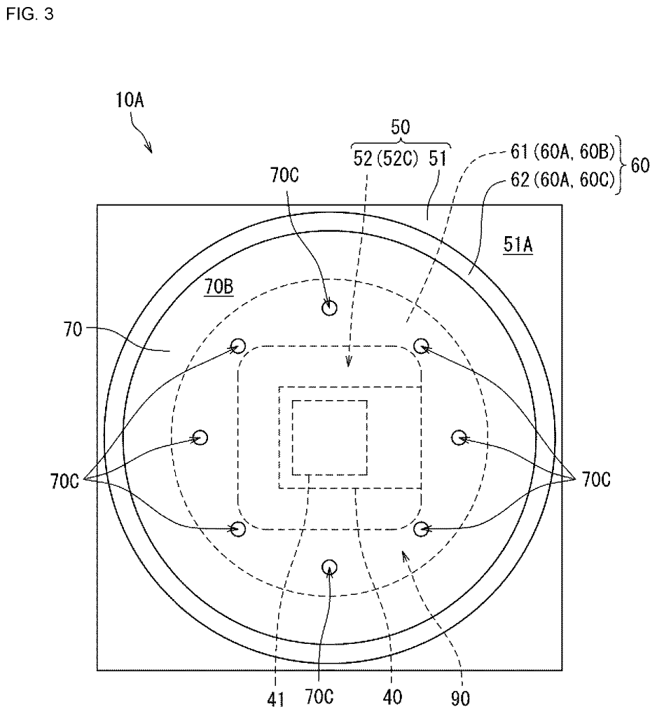

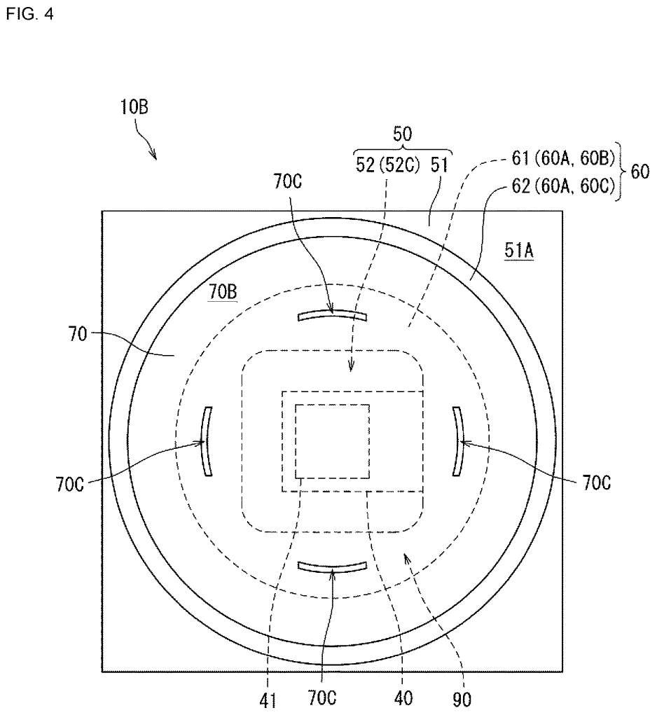

It is also noted that the number, the sizes, and the shapes of the through holes 70C of the cover member 70 are optional. FIG. 3 and FIG. 4 illustrate examples of the configuration of the through holes 70C. FIG. 3 is a schematic plan view of a modification of the pressure sensor according to the first exemplary embodiment of the present disclosure. FIG. 4 is a schematic plan view of a modification of the pressure sensor according to the first exemplary embodiment of the present disclosure. In the following description of the modifications, components described before the following description are given the same reference signs as those in the previous description to omit description thereof basically, and these components will be described, as necessary.

In a pressure sensor 10A of the modification illustrated in FIG. 3, the cover member 70 has eight through holes 70C. In this aspect, the eight through holes 70C are provided at equal intervals on an identical imaginary circular arc as viewed along the vertical direction 100.

In a pressure sensor 10B of the modification illustrated in FIG. 4, the cover member 70 has four through holes 70C. Each of the four through holes 70C is an elongated hole extending along an identical imaginary circular arc as viewed along the vertical direction 100. The four through holes 70C are provided at equal intervals on the identical imaginary circular arc as viewed along the vertical direction 100.

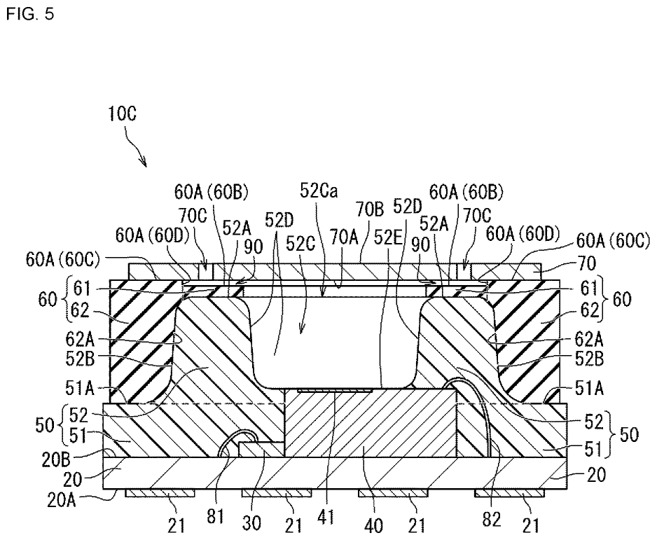

FIG. 5 is a schematic cross-sectional view of a modification of the pressure sensor according to the first exemplary embodiment of the present disclosure, showing a cross-section at a position corresponding to the A-A cross-section of FIG. 1.

In a pressure sensor 10 illustrated in FIG. 1 and FIG. 2, the facing surface 60A of the soft member 60 has the separated surface 60B that is inclined to be separated from the first surface 70A of the cover member 70 as the separated surface 60B approaches the hole portion 52C.

However, as in a pressure sensor 40 illustrated in FIG. 5, the separated surface 60B does not need to be inclined. In other words, the separated surface 60B may be parallel to the support surface 60C. In this case, the facing surface 60A may have a step surface 60D in addition to the separated surface 60B and the support surface 60C.

The step surface 60D is provided between the separated surface 60B and the support surface 60C. In other words, the separated surface 60B and the support surface 60C are connected via the step surface 60D. The step surface 60D extends in the vertical direction 100. The separated surface 60B is located below the support surface 60C. In other words, the separated surface 60B is located closer to the base member 20 than the support surface 60C in the vertical direction 100. Consequently, the gap space 90 is provided between the separated surface 60B and the first surface 70A of the cover member 70.

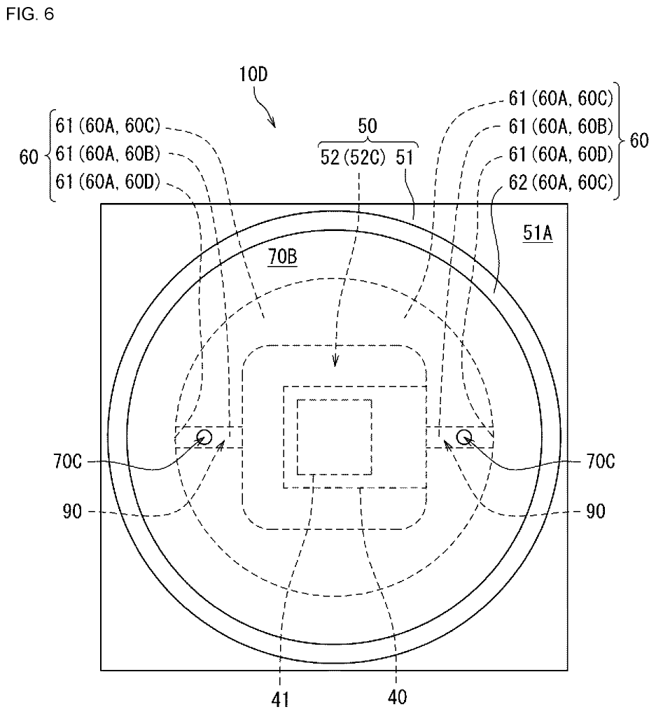

FIG. 6 is a schematic plan view of a modification of the pressure sensor according to the first exemplary embodiment of the present disclosure. In a pressure sensor 10D illustrated in FIG. 6, the separated surface 60B and the step surface 60D are provided at, of the facing surface 60A, a portion in the circumferential direction of the annular protruding portion 52. Consequently, the gap space 90 formed by the separated surface 60B and the step surface 60D has a thin elongated slit shape.

The configuration, such as that illustrated in FIG. 1, in which the separated surface 60B is an inclined surface may be the configuration, such as that illustrated in FIG. 6, in which the gap space 90 has a slit shape. For example, as described above, in FIG. 1, only the region of the facing surface 60A surrounded by the two dash-dotted lines and the two dashed lines may be the separated surface 60B. In this case, a slit-shaped gap space 90A is provided in the region.

According to the first exemplary embodiment, the detection portion 41 of the detection element 40 is connected to the outside of the pressure sensor 10 through the through holes 70C of the cover member 70, the gap space 90, and the hole portion 52C of the covering member 50. Consequently, a pressure applied to the detection portion 41 from the outside can be measured.

According to the first exemplary embodiment, due to the cover member 70 closing the opening 52Ca of the hole portion 52C, adhesion of foreign substances, such as liquid, to the detection portion 41 is suppressed.

When an excessive pressure is applied to the second surface 70B by liquid, such as water, adhering to the second surface 70B of the cover member 70, the soft member 60 is compressed by the pressure. Consequently, the soft member 60 comes into contact with the through holes 70C and closes at least a portion of the gap space 90. As a result, even when liquid adhering to the second surface 70B of the cover member 70 enters the through holes 70C, the possibility of the liquid entering the hole portion 52C and reaching the detection portion 41 is reduced. In other words, the possibility of adhesion of liquid to the detection portion 41 is reduced.

According to the first exemplary embodiment, the entirety or most part of liquid adhering to the second surface 70B of the cover member 70 does not enter the hole portion 52C and remains on the second surface 70B of the cover member 70. Compared with liquid inside the hole portion 52C, the liquid on the second surface 70B of the cover member 70 can be easily removed by, for example, tilting the pressure sensor 10. As a result, measurement by the detection portion 41 can be performed without waiting for complete evaporation of the liquid.

According to the first exemplary embodiment, when the first pressure, which is an excessive pressure, is applied by liquid adhering to the second surface 70B of the cover member 70, at least a portion of the gap space 90 is closed. In this case, there is a likelihood that the liquid on the second surface 70B enters the through holes 70C due to, for example, the first pressure being higher than the surface tension of liquid covering the through holes 70C. However, as described above, since at least a portion of the gap space 90 is closed, a situation in which the liquid passes through the gap space 90 and enters the hole portion 52C is suppressed.

According to the first exemplary embodiment, when the second pressure, which is a slight pressure, is applied to the second surface 70B of the cover member 70, the gap space 90 is not closed. In this case, the liquid on the second surface 70B does not enter the through holes 70C due to, for example, the second pressure being lower than the surface tension of liquid covering the through holes 70C. Therefore, entry of the liquid into the hole portion 52C is suppressed.

According to the first exemplary embodiment, the facing surface 60A of the soft member 60 has the separated surface 60B and the support surface 60C, which are two surfaces different in height. Consequently, the gap space 90 can be formed by the separated surface 60B, and the soft member 60 can support the cover member 70 by the support surface 60C.

According to the first exemplary embodiment, the gap space 90 is realized by inclination of the separated surface 60B of the soft member 60. Consequently, when the soft member 60 is compressed by application of a pressure due to adhesion of liquid to the second surface 70B, the cover member 70 comes, along the inclination of the separated surface 60B of the soft member 60, into close contact with the soft member 60. Therefore, the gap space 90 is efficiently closed.

According to the first exemplary embodiment, since the covering member 50 and the soft member are integrally configured by 60 two-shot molding, the covering member 50 and the soft member 60 is firmly joined.

There is a case where, in a state in which the pressure sensor 10 is attached to a housing (not illustrated) of an electronic device, a gap between the housing and the pressure sensor 10 is sealed by a sealing member such as an O-ring formed by silicone, rubber, or the like. In this case, entry of liquid into the inside of the electronic device from the outside of the electronic device through the gap is suppressed. According to the first exemplary embodiment, the soft member 60 can be used as a sealing member.

### Second Exemplary Embodiment

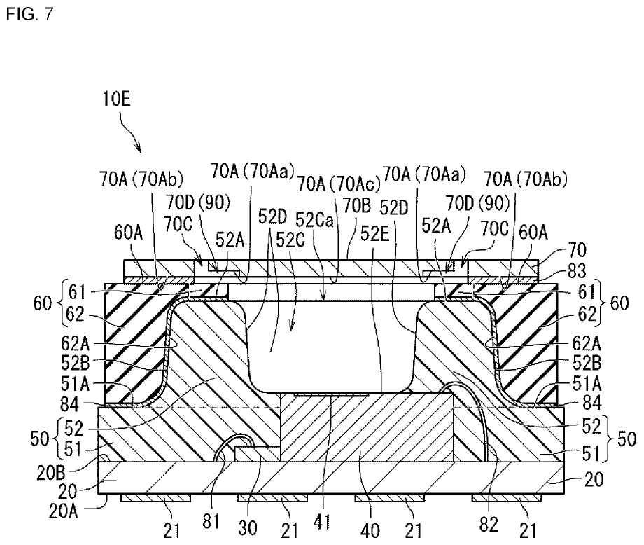

FIG. 7 is a schematic cross-sectional view of a pressure sensor according to a second exemplary embodiment of the present disclosure, showing a cross-section at a position corresponding to the A-A cross-section of FIG. 1. The pressure sensor according to the second exemplary embodiment differs from the pressure sensor according to the first exemplary embodiment in that the cover member 70 has a recessed portion 70D and in that the soft member 60 and the covering member 50 are joined with an adhesive 84. Hereinafter, differences from the first exemplary embodiment will be described. It is noted that features common with the pressure sensor according to the first exemplary embodiment are given the same reference signs as those in the first exemplary embodiment to omit description thereof basically, and these features will be described, as necessary.

As illustrated in FIG. 7, in a pressure sensor 10E according to the second exemplary embodiment, the cover member 70 has the recessed portion 70D at the first surface 70A.

The recessed portion 70D is an upwardly recessed part of the first surface 70A. In other words, the recessed portion 70D is, of the first surface 70A, a part recessed in a direction away from the covering member 50. The recessed portion 70D may be provided to face the soft member 60 in the entire region in the circumferential direction of the annular soft member 60 or provided to face the soft member 60 at a portion in the circumferential direction.

A bottom surface of the recessed portion 70D is a separated surface 70Aa. The separated surface 70Aa is a portion of the first surface 70A. The separated surface 70Aa is separated from the soft member 60. A portion of the separated surface 70Aa faces the support portion 61 of the soft member 60 in the vertical direction 100. Consequently, the gap space 90 is provided between the separated surface 70Aa and the support portion 61. In other words, the separated surface 70Aa is directed to the gap space 90. The remainder of the separated surface 70Aa excluding the portion is directed to the hole portion 52C of the covering member 50. Consequently, the gap space 90 is in communication with the hole portion 52C.

The through holes 70C extend from the separated surface 70Aa of the first surface 70A to the second surface 70B through the cover member 70 in the vertical direction 100. Consequently, the gap space 90 is in communication with the through holes 70C.

The first surface 70A of the cover member 70 has, in addition to the above-described separated surface 70Aa of the recessed portion 70D, a supported surface 70Ab and a closing surface 70Ac.

The supported surface 70Ab is in contact with the soft member 60 and is supported by the soft member 60. In other words, the supported surface 70Ab is located closer to the soft member 60 than the separated surface 70Aa.

The closing surface 70Ac is directed to the hole portion 52C of the covering member 50 in the vertical direction 100. The closing surface 70Ac closes the opening 52Ca of the hole portion 52C. The closing surface 70Ac and the supported surface 70Ab are located on an identical imaginary plane in the second exemplary embodiment but may be located on different imaginary planes.

In the above-described first exemplary embodiment, the facing surface 60A of the soft member 60 is formed by two surfaces (the separated surface 60B and the support surface 60C). In contrast, in the second exemplary embodiment, the facing surface 60A of the soft member 60 is formed by one surface. A portion of the facing surface 60A is directed to the recessed portion 70D of the cover member 70 and faces the separated surface 70Aa in the vertical direction 100. The remainder of the facing surface 60A excluding the portion is in contact with the supported surface 70Ab of the cover member 70 and supports the supported surface 70Ab.

In the exemplary aspect, the facing surface 60A of the soft member 60 may be formed by two surfaces (e.g., the separated surface 60B and the support surface 60C) also in the second exemplary embodiment as with the first exemplary embodiment.

In the pressure sensor 10E according to the second exemplary embodiment, the soft member 60 and the covering member 50 are joined via the adhesive 84, such as a die attach film or a die attach material. The soft member 60 and the cover member 70 are joined via an adhesive 83, such as a die attach film or a die attach material.

According to the second exemplary embodiment, the first surface 70A of the cover member 70 has the separated surface 70Aa and the supported surface 70Ab, which are two surfaces different in height. Consequently, the gap space 90 can be formed by the separated surface 70Aa, and the cover member 70 is supported at the supported surface 70Ab by the soft member 60.

According to the second exemplary embodiment, the shape of the cover member 70 is a shape having the separated surface 70Aa and the supported surface 70Ab. Precisely configuring the dimensions, the positions, and the like of the separated surface 70Aa and the supported surface 70Ab of the cover member 70 is easier than precisely configuring the dimensions, the positions, and the like of the separated surface 60B and the support surface 60C of the soft member 60, which is soft.

According to the second exemplary embodiment, due to the covering member 50 and the soft member 60 being joined with the adhesive 84, joining between the covering member 50 and the soft member 60 is easy.

It should be appreciated that, among the aforementioned various embodiments, any of the embodiments can be combined, as appropriate, to exert respective effects.

In general, it is also noted that the exemplary aspects of the present disclosure have been sufficiently described regarding suitable embodiments with reference to the drawings, as appropriate, while various modifications and corrections are obvious to those skilled in the art. Such modifications and corrections should be understood to be included in the present disclosure.

### REFERENCE SIGNS LIST

10 pressure sensor
20 base member
40 detection element
41 detection portion
50 covering member
51 base portion
52 protruding portion
52A upper surface
52B outside surface
52C hole portion
60 soft member
60A facing surface
60B separated surface
60C support surface
61 support portion
62 surrounding portion
70 cover member
70A first surface
70Aa separated surface
70Ab supported surface
70B second surface
70C through hole
83 adhesive
90 gap space

1. A pressure sensor comprising:
a base member;
a detection element on the base member and including a detection portion;
a covering member on the base member to cover at least a portion of the detection element other than the detection portion and that has a hole portion opened in an upper surface opposite to the base member, such that the hole portion exposes the detection portion;
a soft member supported by the upper surface of the covering member and that is softer than the covering member; and
a cover member supported by the soft member and that closes an opening of the hole portion,
wherein a gap space is present in a portion between the cover member and the soft member,
wherein the cover member has a first surface that is directed to the soft member, a second surface that is opposite to the first surface, and a through hole that extends from the first surface to the second surface, and
wherein the gap space is in communication with both the hole portion and the through hole.

2. The pressure sensor according to claim 1,
wherein a size, a shape, and a position of the through hole are set to satisfy both a first condition and a second condition,
wherein the first condition is a condition under which, when a first pressure is applied to the second surface by liquid adhering to the second surface so as to cover the through hole, liquid covering the through hole enters the through hole, and
wherein the second condition is a condition under which, when a second pressure lower than the first pressure is applied to the second surface by liquid adhering to the second surface so as to cover the through hole, liquid covering the through hole does not enter the through hole.

3. The pressure sensor according to claim 1,
wherein the first pressure is a pressure with which application of the first pressure to the second surface compresses the soft member and thereby causes the soft member to come into contact with the cover member and to close at least a portion of the gap space, and
wherein the second pressure is a pressure with which a state in which the soft member is separated from the cover member is maintained even when the second pressure is applied to the second surface.

4. The pressure sensor according to claim 1, wherein the soft member has a facing surface that faces the first surface, and the facing surface has a separated surface that is directed to the gap space and that is separated from the first surface.

5. The pressure sensor according to claim 4, wherein the facing surface of the soft member has a support surface that is located closer to the first surface than the separated surface and that supports the first surface.

6. The pressure sensor according to claim 5, wherein the separated surface of the facing surface of the soft member is inclined to be separated from the first surface as the separated surface approaches the hole portion.

7. The pressure sensor according to claim 1, wherein the first surface of the cover member includes:
a separated surface that is directed to the gap space and that is separated from the soft member, and
a supported surface that is located closer to the soft member than the separated surface and that is supported by the soft member.

8. The pressure sensor according to claim 1, wherein the covering member and the soft member are integrally configured.

9. The pressure sensor according to claim 1, further comprising an adhesive that couples the covering member to the soft member.

10. The pressure sensor according to claim 1, wherein the covering member includes:
a base portion that covers the detection element, and
a protruding portion that protrudes from the base portion and that has the hole portion.

11. The pressure sensor according to claim 10, wherein the soft member includes:
a support portion that is supported by an upper surface of the protruding portion, and
a surrounding portion that surrounds the protruding portion as viewed along a protruding direction of the protruding portion and that is in contact with an outside surface of the protruding portion.

12. The pressure sensor according to claim 1, wherein the hole portion has a tapered shape in which a cross-sectional area along an imaginary surface orthogonal to a direction from the base member toward the cover member decreases from the opening toward the detection portion of the detection element.

13. The pressure sensor according to claim 1, wherein the detection portion includes a passivation film.

14. The pressure sensor according to claim 1, wherein the soft member comprises silicone or rubber.

15. The pressure sensor according to claim 1, wherein the through hole is one of a plurality of through holes in the cover member, and the plurality of through holes are disposed at positions that are point-symmetric with respect to a center of the pressure sensor as viewed along a direction from the base member toward the cover member.

16. The pressure sensor according to claim 1, wherein the cover member is harder than the soft member.

17. The pressure sensor according to claim 1, further comprising a circuit element on the base member and electrically connected to the detection element, wherein the circuit element includes a signal processing circuit configured to process a signal output from the detection element, and wherein the covering member embeds the circuit element.

18. The pressure sensor according to claim 1, further comprising at least one bonding wire that electrically connects the detection element to the base member, wherein the at least one bonding wire is embedded in the covering member.

19. The pressure sensor according to claim 2, wherein the first pressure is higher than 100 kilopascals and the second pressure is lower than 100 kilopascals.

20. The pressure sensor according to claim 5, wherein the facing surface of the soft member comprises a step surface provided between the separated surface and the support surface, the step surface extending in a direction from the base member toward the cover member, and the separated surface is parallel to the support surface.
